(19) United States
(12) Patent Application Publication
(10) Pub. No.: US 2005/0203279 A1
(43) Pub. Date: Sep. 15, 2005

(54) Process of refinement of crude tall oil using short path distillation

(76) Inventors: Alejandro Markovits Rojas, Santiago (CL); Andres Markovits Schersl, Santiago (CL); Miguel Angel Fuenzalida Diaz, Santiago (CL)

Correspondence Address: David I. Roche;BAKER & McKENZIE LLP, 130 E. Randolph Drive, Chicago, IL, 60601, US

(21) Appl. No.: 11/121,269

(22) Filed: May 3, 2005

Related U.S. Application Data
(63) Continuation of application No. 11/051,766, filed on Feb. 4, 2005.

(30) Foreign Application Priority Data
Feb. 6, 2004 (CL) 206-2005

(51) Int. Cl. C09F 1/00

(52) U.S. Cl. 530/205

(57) ABSTRACT

The present invention is related to a process for the production of high quality fatty acids and rosin acids and their mixtures from crude tall oil by means of short path distillation of saponified crude tall oil, acidulation and fractionation by distillation.

This application is a CONTINUATION of prior U.S. application Ser. No. 11/051,766, which was filed on Feb. 4, 2005.

### BACKGROUND AND SUMMARY OF THE INVENTION

The present invention is related to a process for obtaining a high quality mixture of fatty and rosin acids from crude tall oil through short path distillation of saponified tall oil. The present invention is also related to a process for obtaining high quality fatty and rosin acids from crude tall oil through short path distillation of saponified crude tall oil.

Tall oil is obtained through acidulation of black liquor soaps, which in turn are by-products of the Kraft pulping of wood for obtaining cellulose. This process consists of the digestion of wood chips at high temperature and pressure in diluted alkaline liquor containing sodium hydroxide and sodium sulfide as active ingredients. The digestion disrupts the cellular structure and causes the dissolution of lignin, other chemical products contained in the wood and hemicellulose. The cellulose fiber dispersed in the spent liquor from the digestion is isolated by filtration. The Spent liquor, known as black liquor, is further evaporated and calcinated for the recovery of salts and alkalis, which return to the Kraft pulping process. This operation is performed by feeding the black liquor through a series of multi-effect evaporators. After several stages of evaporation and when the concentration of solids is around 30%, a portion of the solids, known as black liquor soaps, becomes insoluble. At these conditions, the black liquor is transferred to skimming tanks where the black liquor soaps are separated on the upper part of the tank where they are isolated or skimmed out and recovered. The skimmed consists of a mixture of pasty matter with a water content between 30 and 50%.

Black liquor soaps are mainly composed by fatty and rosin acid soaps and unsaponifiable matter and minor amounts of partially soluble inorganic sodium salts, lignin, mercaptans, polysulfides, compounds that provide the dark color and suspended fibers occasionally.

Typically, black liquor soaps are transformed into crude tall oil, which in turn can be processed, for example using distillation to produce different fractions of distilled tall oil.

The first step for transforming black liquor soaps consists on reacting them with sulfuric acid, which convert them into their respective free acids (fatty and rosin acids). The result of the acidulation is generally separated in three phases. The upper layer is called crude tall oil (CTO), and its main components are fatty and rosin acids, unsaponifiable matter, esters and some suspended solids and water. The second layer or middle layer contains most of the lignin and insoluble solids originally present in black liquor soaps. The lower layer or brine is fundamentally composed of water and sodium sulfate. Crude tall oil can be commercialized as such or refined using fractionated distillation. In the present invention, unsaponifiable matter is defined as the compounds present in crude tall oil which can not be saponified.

Crude tall oil is characterized by its acid number and saponification index. The acid number expresses the milligrams of KOH required to neutralize one gram of crude tall oil and the saponification index, the milligrams of KOH required to saponify one gram of crude tall oil. Table 1 shows typical values of acid number and saponification index in crude tall oil. In general, the lower the acid number, the lower the content of fatty and rosin acids, and therefore, the higher the content of unsaponifiable matter in crude tall oil.

TABLE 1
Typical values of acid number and saponification index
in crude tall oil samples

| | Acid number | Saponification index |
|---|---|---|
| | mg KOH/g CTO | mg KOH/g CTO |
| Southeast U.S.A. | 165 | 172 |
| North U.S.A. and Canada | 135 | 166 |
| Scandinavia | 132 | 142 |
| Chile | 148 | 161 |

Crude tall oil is a dark-brown, cloudy liquid with a distinctive odor. Multiple compounds such as pinosylvindimethyl ether provides the dark color. A color measurement used in the industry of tall oil by-products is the Gardner color scale. The distinctive odor is due in part to the presence of sulfur products as organic polysulfides.

Crude tall oil has few direct applications mainly because it is a complex and variable mixture. In addition, the applicability of crude tall oil is even more limited because of the content of unsaponifiable matter, color and distinctive odor. Thus one of its main uses is as alternative fuel.

In the industry, crude tall oil is processed by vacuum distillations to recover fractions of fatty acids or TOFA (Tall Oil Fatty Acids) and rosin acids or TORA (Tall Oil Rosin Acids) of higher purity. Nevertheless, direct distillation of crude tall oil has the disadvantage that the unsaponifiable matter distills along with the fatty and rosin acids fractions. This situation forces the use of multiple distillation stages and high reflux rates in the distillation columns with a high impact in capital inversion and operation costs. In turn, multiple distillation stages cause thermal decomposition of tall oil compounds, affecting performance, purity and color of the final products.

Finally, the presence of unsaponifiable matter generates multiple side stream in the fractionation process of crude tall oil; for example, tall oil heads, mainly composed by fatty acids and unsaponifiable matter, distilled tall oil or DTO, a mixture of fatty and rosin acids and unsaponifiable matter, and tall oil pitch mainly composed by rosin acids and esters from the reaction of fatty and rosin acids with unsaponifiable matter. Therefore, an important amount of fatty and rosin acids are lost in the side streams, which negatively affect the recovery performances. In addition, the purified fractions of TOFA and TORA are unsatisfactory in applications where odorless, colorless and highly pure materials are required. Generally, in the TOFA industry, one or more distillations are required in order to obtain acceptable levels of purity and color, which, however, in many cases are not enough to compete with fatty acids from other origin.

Consequently, in order to obtain better quality fatty acids or rosin acids, the efforts made by the tall oil industry have been focused on developing techniques of unsaponifiable matter separation; although there are not processes known in the state of the art that satisfactorily solve this problem so far.

The interest on developing refining processes of CTO has recently increased due to many applications that have been found for the different components of the unsaponifiable matter of CTO. Thus, there are multiple refining processes of tall oil using solvent extraction. Harada et al. discuss the disadvantages of these techniques in U.S. Pat. No. 3,887,537.

Harada et al. in U.S. Pat. No. 4,076,700 disclose a process for recovering fatty and/or rosin acids from black liquor soap without using solvent extraction of the unsaponifiable matter. In the disclosed process, black liquor soaps with water content of around 40% are firstly fed to a saponification reactor where an alkaline solution is added. Then, soaps from the reactor with a water content of around 50% are fed to a thin film evaporator where the distance or clearance between the blade scraper and the evaporating surface is very short, lesser than 1 mm, at pressure between 10 and 50 mmHg. The reason for using such close blade scrapers, practically in contact with the surface, is due to the strong decompression of the black liquor soap solution and the strong foaming of the black liquor soap solution at the operation pressure that cause the solidification of the black liquor soaps on the surface of the evaporator. Therefore, the only efficient way for removing them is to use highly near to the surface blade scrapers. On the other hand, it is not possible to increase the temperature excessively in order to keep the black liquor soaps melted because of the thermal degradation of black liquor soaps. According to the inventors, it must be used the lowest pressure possible which in the case of a thin film evaporator is not lower than a few mmHg, and temperatures over the melting point of black liquor soaps at the operation pressure. In the thin film evaporator, water and light unsaponifiable matter of black liquor soaps are removed at 230° C. and a pressure between 10 and 50 mmHg. Then, melted black liquor soaps are fed to a second thin film evaporator where unsaponifiable matter is distillated. For this, the pressure in the evaporator must be the lowest as possible in order to evaporate the unsaponifiable matter at low temperature with the aim of avoiding thermal decomposition of black liquor soaps. Then the soaps without unsaponifiable matter are acidulated to transform them into refined tall oil, which is distilled according to known processes to produce TORA and TOFA. The disclosed process in U.S. Pat. No. 4,076,700 provides a TORA and TOFA product with an unsaponifiable matter higher than 2%.

The disclosed process has many drawbacks and is inefficient to remove unsaponifiable matter entirely from black liquor soaps, affecting production performance and quality of TORA and TOFA products. Firstly, the high water content of black liquor soap and then the product from the saponification stage which fed the first thin film evaporator, cause an excessive foaming which obstructs the drying operation of black liquor soap and forces the use of a very large evaporation area. In addition, operation pressure in the evaporator is lower than 50 mmHg, which increases flashing and foaming problems. Along with this, the flashing soap commonly reaches the condenser, blocking it due to its high melting point and the relative low temperature of the condensing fluid.

Furthermore, 38° C. or lower temperature is required in the condensing fluid to condense the evaporated water at 50 mmHg. However, light unsaponifiable matter has a melting point higher than 35° C., then, for this reason, it is inefficient to condense water along with light unsaponifiable matter, generating high vapor loads to the vacuum system and frequent accumulations of solidified unsaponifiable matter in the condenser, which affect continuity and productivity of the process.

The strong flash effect in the first thin film evaporator produces solidification of soaps; therefore, their removal requires blade scrapers located closely to the surface, practically in contact with them, which implies the use of high torque engines, high energy consumption and abrasion-resistant materials, which has a negative impact on maintenance and operation of thin film evaporators.

On the other hand, given the limitations to reach low pressures in thin film evaporators due to the distance between the external condenser and the evaporation surface, nominal pressure of operations is not lower than 1 mmHg. Therefore, in order to evaporate unsaponifiable matter in an efficient way, high temperatures are needed which cause quick thermal degradation of fatty or rosin acid salts. Accordingly, lower temperatures are required to operate and, therefore an incomplete removal of the unsaponifiable matter, which explains why the process disclosed by Harada et al. provides TORA and TOFA products with unsaponifiable matter content higher than 2%.

The process in the present invention does not have any of the drawbacks of the processes disclosed so far. Thus, the first objective of the present invention is to provide an efficient process to produce refined tall oil or RTO free from unsaponifiable matter that distills along with fatty and rosin acids.

The second objective of the present invention is to provide an efficient process to produce a highly pure mixture of fatty and rosin acids or extracted tall oil (ETO) with an unsaponifiable matter content lower than 2%.

The third objective of the present invention is to provide an efficient process to produce highly pure fatty and rosin acids with an unsaponifiable matter content lower than 2%.

According to the present invention, crude tall oil is saponified in a reactor to produce saponified tall oil with low water content. The reaction is carried out by contacting crude tall oil with an alkali solution, preferably sodium hydroxide or potassium hydroxide, at a temperature between 80° C. and 200° C., in agitated reactors at pressure between 1 and 15 atm. The required amount of alkali is obtained from the saponification index of crude tall oil. Generally, a small amount is used (lower than 5%) over the stoichiometric value given by the saponification index. The acid number of crude tall oil and the water content of alkali solution provide the water content in the saponified tall oil. For the objectives of the present invention, it is convenient to decrease the water content of saponified tall oil. For this, alkali-saturated solutions or mixtures of alkali-saturated solutions and solid alkali are used. In this way, saponified tall oil has a water content lower than 20%, preferably lower than 15%.

Next, saponified tall oil is dried or dehydrated by feeding it to an evaporator, preferably a short path evaporator, which works at pressure between 150 and 1500 mmHg, preferably at atmospheric pressure, and at temperature higher than 100° C. to produce a distillate comprising water and light unsaponifiable matter, and a residue comprising dehydrated saponified tall oil with a water content lower than 3%, preferably lower than 1%.

According to the disclosed drying process of saponified tall oil in the present invention, water can be evaporated avoiding flashing, foaming and splashing problems known in the state of the art. Furthermore, the drying process at a pressure close to atmospheric allows the temperature set up of the condensation fluid in order to condense water efficiently and to maintain the condensed unsaponifiable matter in a fluid state. The condenser temperature work range is between 20 and 120° C., preferably over 50° C.

Due to the fluidity of saponified tall oil descends as water content decreases, it is convenient to provide more than one thermal level area to the evaporator used in the drying process of saponified tall oil. This is done by using independent jackets along the evaporator, which allows gradual heating of saponified tall oil until a temperature slightly over the fusion point is fluidly reached, diminishing thermal degradation of saponified tall oil.

Preferably, dehydrated saponified tall oil is further processed through an expansion stage by feeding it to an expansion system where the pressure is reduced to a value lower than 25 mmHg and at a temperature higher than the melting point of dehydrated saponified tall oil. This system may be a jacketed tank or an evaporator, whose heating surface works at temperatures between 200 and 350° C. and condensation surface operates at temperatures between 50 and 140° C. The condensate comprising mainly unsaponifiable matter is collected through the condenser, and a residue is collected through the bottom.

Then, dehydrated saponified tall oil or the residue from the expansion stage of the drying stage is fed to a high-vacuum short path evaporator, which operates at a pressure lower than 1 mmHg, preferably 0.1 mmHg, a temperature of the evaporation surface between 240 and 380° C. and a temperature of the condensation surface between 70 and 180° C. In a short path evaporator, it is possible to work at pressures as low as 0.001 mmHg because pressure drop between the evaporator and the condenser is very low due to the close distance between the evaporator and the condenser. Because reachable pressures are very low in a short path evaporator, it is possible to remove unsaponifiable matter efficiently and at temperatures that minimize thermal decomposition of saponified tall oil. Therefore, the problem of high content of unsaponifiable matter that distills along with TORA and TOFA from the process disclosed by Harada et al. is solved. Thus, a condensate comprising unsaponifiable matter is collected through the condenser and a residue or refined saponifed tall oil free of unsaponifiable matter that distills along with fatty and rosin acids is recovered through the bottom.

The refined saponified tall oil is mixed with water and acidulated with mineral acids, such as sulfuric acid, to produce a mixture that is separated in two phases. An oily phase is obtained, which comprises fatty and rosin acids, and it is characterized by a low content of unsaponifiable matter; also an aqueous phase or brine composed by an aqueous solution of sodium sulfate is obtained. This brine may be conveniently recycled to the mixing stage of refined saponified tall oil with water. It can be also recycled to the acidulation stage.

Then, oily phase is dehydrated in conventional evaporation systems, preferably at reduced pressures and temperature over 80° C. to collect water of the oily phase through the condenser and a residue through the bottom comprising refined tall oil or RTO free of unsaponifiable matter that distills along with fatty and rosin acids. Typically, RTO contains a percentage of unsaponifiable matter equal to or lower than the initial percentage of the unsaponifiable matter in crude tall oil and these unsaponifiable matter fraction has a vapor pressure substantially lower than fatty and rosin acids, allowing an further easy separation through distillation. In this way, the first objective of the present invention is achieved.

Refined tall oil can be directly used in industrial applications in detergents, surfactants and chemicals for mining, among others.

In order to achieve the second objective of the present invention, refined tall oil produced through the described invention is distilled in a short path evaporator or thin film evaporator at reduced pressure, lower than 100 mmHg, preferably lower than 25 mmHg, and at temperatures of the evaporation surface between 160 and 300° C., preferably between 200 and 250° C., and at temperatures of the condensation surface between 60 and 140° C., preferably 80 and 120° C., to collect a residue or pitch containing unsaponifiable matter through the bottom and a highly pure mixture of fatty and rosin acids or extracted tall oil (ETO) through the condenser with an unsaponifiable matter percentage less than 2%.

In order to achieve the third objective of the present invention, RTO or ETO produced through the invented process is fed to a distillation system to obtain high quality fatty and rosin acids. The distillation process of RTO or ETO may be carried out in the distillation systems described in the state of art, by means of the use of falling film evaporators, short path evaporators along with packed fractionation columns at reduced pressure with or without steam and, generally, the same systems and processes used for fractionating CTO. U.S. Pat. Nos. 2,716,630; 2,724,709; 2,866,492; 2,894,880; and 3,644,179 describe processes that may be used for fractionating RTO or ETO.

The processes for obtaining fatty and rosin acids from the distillation of RTO or ETO have more efficiency and higher performance because they need less theoretical distillation stages, shorter distillation times, lesser reflux ratios and they generate lesser thermal degradation and lower volume of side streams with the consequent better quality products and higher performances in comparison with conventional distillation of CTO as is shown in example 3.

The processes of the present invention are further described in reference of the accompanying figures:

### BRIEF DESCRIPTION OF THE DRAWINGS

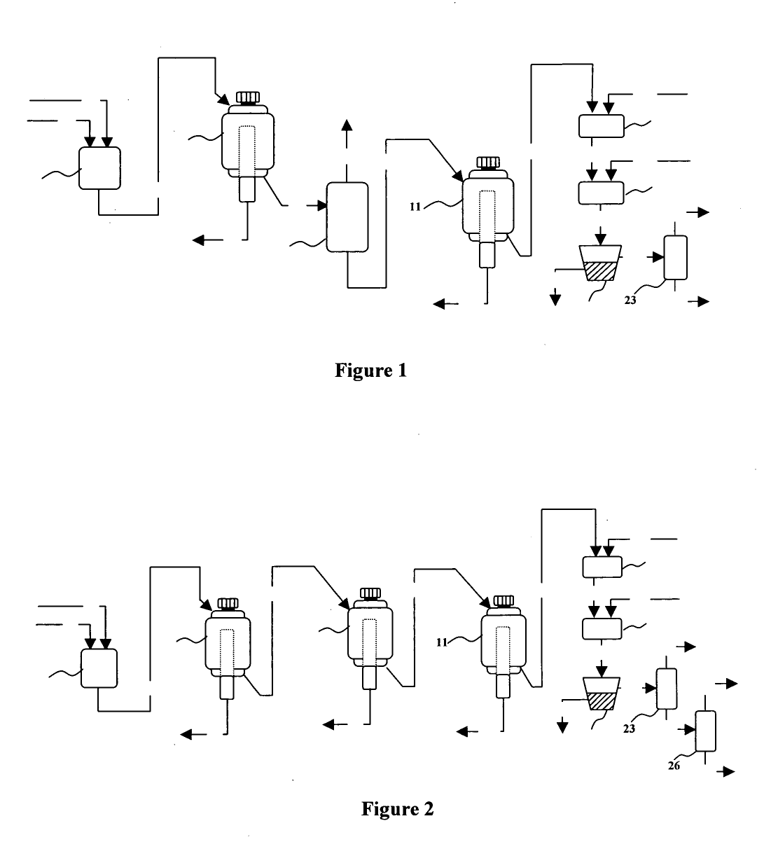

The diagram of FIG. 1 describes the process for obtaining refined tall oil or RTO from crude tall oil.

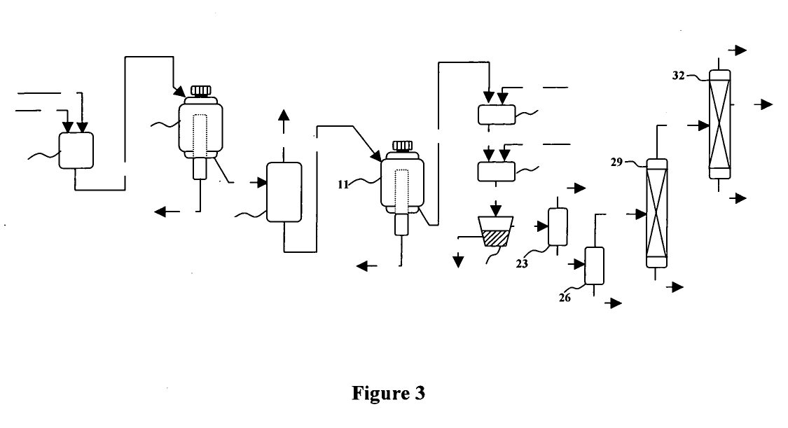

The diagram of FIG. 2 describes the process for obtaining extracted tall oil from crude tall oil.

The diagram of FIG. 3 describes the process for obtaining highly pure fatty and rosin acids from crude tall oil.

### DETAILED DESCRIPTION OF THE INVENTION

In FIG. 1, crude tall oil is fed to a saponification reactor 3 via line 1, to which a stream of a solution of sodium hydroxide in a equivalent proportion to the saponification index or in excess up to 20% is fed via line 2. Reactor 3 works at a temperature between 80 and 200° C. under agitation, and at pressure between 1 and 15 atm to generate saponified tall oil. This saponified tall oil is fed to a short path evaporator 5 via line 4, which operates at a pressure between 150 and 1500 mmHg, preferably between 600 and 800 mmHg and at a temperature between 100 and 300° C., to recover a condensate comprising water and unsaponifiable matter via line 6. The residue from the short path evaporator 5 is fed to an expansion tank 8 via line 7, which works at a pressure between 1 and 50 mmHg and at temperature between 200 and 350° C., to recover a condensate comprising mainly unsaponifiable matter via line 9 and a second residue through the bottom. The second residue is fed to a second short path evaporator 11 via line 10, which works at a pressure lower than 1 mmHg and at temperature higher than 240° C., to recover a condensate comprising unsaponifiable matter via line 12 and a residue comprising refined saponified tall oil through the bottom. The refined saponified tall oil is fed to the diluter 14 via line 13, to which a water stream is fed via line 15 to form an aqueous solution of refined saponified tall oil with a solid content between 20 and 80%. The aqueous solution of refined saponified tall oil is fed via line 16 to the acidulation reactor 17, to which a sulfuric acid stream is fed via line 18. The acidulation reactor 17 operates at a temperature between 50 and 150° C. to produce an immiscible mixture, which is then fed via line 19 to a decanter tank 20 where the phases are separated. The lower phase mainly comprising an aqueous solution of sodium sulfate brine is separated via line 21. Via line 22, the upper phase or oily phase is separated and fed to dehydrating system 23 to recover an aqueous current via line 24 and a dehydrated oily phase via line 25 or refined tall oil or RTO.

In FIG. 2, crude tall oil is fed to a saponification reactor 3 via line 1, to which a stream of a solution of sodium hydroxide in a equivalent proportion to the saponification index or in excess up to 20% is fed via line 2. Reactor 3 works at a temperature between 80 and 200° C. under agitation, and at pressure between 1 and 15 atm to generate saponified tall oil. This saponified tall oil is fed to a short path evaporator 5 via line 4, which operates at a pressure between 150 and 1500 mmHg, preferably between 600 and 800 mmHg and at a temperature between 100 and 300° C., to recover a condensate comprising water and unsaponifiable matter via line 6. The residue from the short path evaporator 5 is fed to a second short path evaporator 8 via line 7, which works at a pressure between 1 and 50 mmHg and at temperature between 200 and 350° C., to recover a condensate mainly comprising unsaponifiable matter via line 9 and a second residue through the bottom. The second residue is fed to a third short path evaporator 11 via line 10, which operates at a pressure lower than 1 mmHg and at a temperature higher than 240° C., to recover a condensate comprising unsaponifiable matter via line 12 and residue comprising refined saponified tall oil through the bottom. The refined saponified tall oil is fed via line 13 to the diluter 14, to which a stream of water is fed via line 15 to form an aqueous solution of refined saponified tall oil with a solid content between 20 and 80%. The aqueous solution of refined saponified tall oil is fed to the acidulation reactor 17 via line 16, to which a sulfuric acid stream is fed via line 18. The acidulation reactor 17 operates at a temperature between 50 and 150° C. to produce an immiscible mixture, which then is fed via line 19 to the decanter tank 20 where the phases are separated. The lower phase mainly comprising a solution of sodium sulfate or brine is separated via line 21. Via line 22, the upper phase or oily phase is separated and fed to a dehydrating system 23 to recover an aqueous stream via line 24 and a dehydrated oily phase or RTO via line 25, which is fed to the short path evaporator 26 to recover a residue via line 27 and distillate via line 28 or extracted tall oil or ETO.

In FIG. 3, crude tall oil is fed to a saponification reactor 3 via line 1, to which a stream of a solution of sodium hydroxide in a equivalent proportion to the saponification index or in excess up to 20% is fed via line 2. Reactor 3 works at a temperature between 80 and 200° C. under agitation, and at pressure between 1 and 15 atm to generate saponified tall oil. This saponified tall oil is fed to a short path evaporator 5 via line 4, which operates at a pressure between 150 and 1500 mmHg, preferably between 600 and 800 mmHg and at a temperature between 100 and 300° C., to recover a condensate comprising water and unsaponifiable matter via line 6. The residue from the short path evaporator 5 is fed to an expansion tank 8 via line 7, which operates at a pressure between 1 and 50 mmHg and a temperature between 200 and 350° C., to recover a condensate mainly comprising unsaponifiable matter via line 9 and a residue via line 10, which is fed to a second short path evaporator 11, which operates at a pressure lower than 1 mmHg and a temperature higher than 240° C., to recover condensate comprising mainly unsaponifiable matter via line 12 and residue comprising refined saponified tall oil through the bottom. Refined saponified tall oil is fed via line 13 to the diluter 14, to which a stream of water is fed via line 15 to form an aqueous solution of refined saponified tall oil with a solid content between 20 and 80%. The aqueous solution of refined saponified tall oil is fed to the acidulation reactor 17 via line 16, to which a sulfuric acid stream is fed via line 18. The acidulation reactor 17 operates at a temperature between 50 and 150° C. to produce an immiscible mixture, which is fed via line 19 to the decanter tank 20, where the phases are separated. The lower phase mainly comprising a solution of sodium sulfate or brine is separated via line 21. Via line 22, the upper phase or oily phase is separated and fed to dehydrating system 23 to recover an aqueous stream via line 24 and a dehydrated oily phase via line 25, which is fed to the thin film evaporator or falling film evaporator 26, which works at reduced pressure and at a temperature over 250° C., to recover a residue via line 27 and a distillate which is fed to fractionation column 29 via line 28. A highly pure rosin acid stream is separated from column 29 via line 30. Column 32 is fed via line 31 to produce a stream 33 comprising a fatty and rosin acid mixture essentially free of unsaponifiable matter; a stream 34 comprising highly pure fatty acids, mainly oleic and linoleic acids; and a stream 35 comprising highly pure fatty acids mainly palmitoleic acid.

### EXAMPLE 1

550 g of crude tall oil with an acid number of 146, an saponification index of 157 and an unsaponifiable matter content of 17.6% are saponified in a 2000-ml reactor, connected to a reflux condenser and with mechanical agitation, with 125 g of sodium hydroxide at 50% under reflux for two hours to generate saponified tall oil with a water content of 13.1%.

200 g of saponified tall oil are fed to the feeding funnel of a short path evaporator model UIC KDL-5. The temperature of the jacket of the feeding funnel is set at 110° C. under agitation and inert atmosphere. The temperature of the evaporator jacket is set at 210° C.; temperature of the condenser, 70° C.; evaporator residue jacket, 240° C. and operation pressure, 700 mm Hg.

Saponified tall oil is fed to the evaporator at 0.8 kg/h, and 172 g of first residue with a water content of 0.41% is recovered. A mixture of water and unsaponifiable matter with a non-volatile content of 9.1% is recovered in the distillate.

150 g of the first residue are fed to the feeding funnel of the short path evaporator model UIC KDL-5. The temperature of the jacket of the feeding funnel is set at 240° C. under agitation and inert atmosphere. The temperature of the evaporator jacket is set at 280° C.; temperature of the condenser, 140° C.; evaporator residue jacket, 240° C.; and operation pressure, 0.3 mmHg.

The first residue is fed to the evaporator at 0.2 kg/h, and 129.7 g of residue comprising refined saponified tall oil are recovered. 115 g of refined saponified tall oil are dissolved in 100 g of water in an agitated reactor at 50° C. The solution of refined saponified tall oil is acidulated with 100 g of an 18.5% aqueous solution of sulfuric acid at reflux for one hour. Then, the mixture is left to decant and is separated into two phases: a heavy aqueous phase or brine and a light oily phase, which is washed with water up to pH 5.

The oily phase is dehydrated in a rotavapor until reaching a reduced pressure of 100 mmHg and a thermostated bath temperature of 120° C., and 102 g of refined tall oil or RTO are recovered. Table 2 shows the characteristics of the RTO obtained and the original CTO.

TABLE 2
Characteristics of RTO and CTO

| Characteristics | Crude tall oil | Refined tall oil |
|---|---|---|
| Acid number | 146 | 186 |
| Saponification index | 157 | 186 |
| Unsaponifiable matter percent | 17.6 | 2.2 |
| Fatty acid percent | 34.1 | 49.1 |
| Rosin acid percent | 48.3 | 48.6 |
| Gardner color | 13 | 9 |

### EXAMPLE 2

160 g of crude tall oil are processed according the example 1 and 98 g of refined tall oil are produced.

90 g of refined tall oil are fed to the feeding funnel of a short path evaporator model UIC KDL-5. The temperature of the jacket of the feeding funnel is set at 120° C. under agitation and inert atmosphere. The temperature of the evaporator jacket is set at 200° C.; temperature of the condenser, 90° C.; jacket of the residue evaporator, 150° C.; and operation pressure, 1 mmHg.

The evaporator is fed at 0.6 kg/h, and 79 g of distillate comprising extracted tall oil or ETO is recovered. Table 3 shows the characteristics of the ETO obtained and the original CTO.

TABLE 3
Characteristics of ETO and CTO

| Characteristics | Crude tall oil | Extracted tall oil |
|---|---|---|
| Acid number | 146 | 190 |
| Saponification index | 157 | 190 |
| Unsaponifiable matter percent | 17.6 | 0.3 |
| Fatty acid percent | 34.1 | 47.7 |
| Rosin acid percent | 48.3 | 51.7 |
| Gardner color | 13 | 1 |

### EXAMPLE 3

2000 g of crude tall oil are processed according Example 1. 1236 g of refined tall oil are recovered.

900 g of refined tall oil are fed to a 2000-ml round flask connected to a 66-cm packed fractionation column with 3-mm aleatory Poropack packing and a distillation condenser head with reflux control.

Distillation is performed at a reduced pressure of 3 mmHg and at a temperature of the reboiler between 200 and 370° C. Distillate is separated into five fractions analyzed through gas chromatography. The distillation objective is to generate a fraction 1 comprising fatty acids with less than 18 carbon atoms, a fraction 2 with fatty acids with 18 carbon atoms free of rosin acids, a fraction 3 comprising a mixture of fatty and rosin acids, a fraction 4 comprising rosin acids free of fatty acids and a fraction 5 or distillation residue.

Similarly, 900 g of crude tall oil are distilled under the same equipment configuration, operation and control conditions used in the distillation of refined tall oil in order to compare the products and the process performance of crude tall oil and refined tall oil.

Table 3 shows the comparative results of fractionated distillation of crude tall oil and refined tall oil.

As shown in Table 3, the fraction of fatty acids (Fraction 2) and the fraction of rosin acids (Fraction 4) obtained through the distillation of refined tall oil have better quality in comparison to the respective fractions obtained through the distillation of crude tall oil. Besides, a notable improvement can be observed in the organoleptic properties of the fractions obtained through the distillation of refined tall oil.

TABLE 3
Characterization of distillation fractions from CTO and RTO

| | Crude tall oil | Refined tall oil |
|---|---|---|
| Fraction 1 | | |
| Acid number | 154.0 | 210.2 |
| Unsaponifiable matter percent | 27.0 | 0.6 |
| Fatty acid percent | 71.0 | 98.2 |
| Rosin acid percent | 0.0 | 0.0 |
| Gardner color | 8 | 1 |
| Fraction 2 | | |
| Acid number | 184.5 | 198.9 |
| Unsaponifiable matter percent | 7.2 | 0.3 |
| Fatty acid percent | 90.7 | 98.1 |
| Rosin acid percent | 2.2 | 1.3 |
| Gardner color | 5 | 1 |
| Fraction 3 | | |
| Acid number | 156.2 | 188.3 |
| Unsaponifiable matter percent | 18.4 | 0.5 |
| Fatty acid percent | 41.4 | 57.8 |
| Rosin acid percent | 40.2 | 40.3 |
| Gardner color | 6 | 1 |
| Fraction 4 | | |
| Acid number | 162.7 | 182.2 |
| Unsaponifiable matter percent | 12.6 | 0.4 |
| Fatty acid percent | 2.3 | 0.7 |
| Rosin acid percent | 85.1 | 98.2 |
| Gardner color | 7 | 1 |

FIG. 1 shows time and performance of distillation obtained from fractionated distillations of crude tall oil and refined tall oil.

As shown in Graph 1, the distillation of refined tall oil was carried out in half of the time required in the distillation of crude tall oil, which yields to a positive impact on the economy of the distillation process. Furthermore, recovery performance of fatty and rosin acid fractions from the distillation of refined tall oil is highly superior to the distillation of crude tall oil, having a positive impact on the process productivity.

[image]

While the present has been described in conjunction with the specific embodiments and examples, as set forth above, many alternatives, modifications and variations thereof will be apparent to those of ordinary skill in the art. All such alternatives, modifications and variations are intended to fall within the spirit and scope of the present invention.

1. A process for the production of fatty acids and rosin acids from crude tall oil comprising the steps:
a) saponifying crude tall oil with sodium or potassium hydroxide or with an aqueous solution of sodium or potassium hydroxide to form saponifyed crude tall oil comprising unsaponifiable matter, sodium or potassium soaps of fatty acids and rosin acids and 40% in weight or less of water;
b) dehydrating saponifyed crude tall oil to form dehydrated saponifyed crude tall oil;
c) distilling dehydrated saponifyed crude tall oil to form a distillate comprising unsaponifyable matter and a residue comprising sodium or potassium soaps of fatty acids and rosin acids;
d) contacting the residue of step c) with sulfuric acid to form refined tall oil comprising fatty acids and rosin acids and an aqueous solution comprising sodium or potassium sulfate;
e) separating the refined tall oil of step d) from the aqueous solution, and
f) vacuum fractionating the refined tall oil of step e) to form a first fraction comprising fatty acids and a second fraction to form rosin acids.

2. The process according to claim wherein in step a) the sodium or potassium hydroxide comprise less than 15% in weight of water.

3. The process according to claim 1 wherein in step a) the aqueous solution of sodium or potassium hydroxide comprise less than 50% in weight of water.

4. The process according to claims 1, 2, or 3 wherein the saponifyed crude tall oil comprise less than 25% in weight of water.

5. The process according to claim 4 wherein the first and second fractions comprise less than 2% in weight of unsaponifiable matter and have a Gardner color of less than 2.
